(19) United States
(12) Patent Application Publication
(10) Pub. No.: US 2025/0270091 A1
(43) Pub. Date: Aug. 28, 2025

(54) Textile Fibres

(71) Applicants: North Carolina State University, Raleigh, NC (US); University of Surrey, Guildford (GB)

(72) Inventors: Melis Seher DUYAR, Surrey (GB); Thomas RAMIREZ REINA, Surrey (GB); Silvia PARILLA LAHOZ, Surrey (GB); Joel PAWLAK, Raleigh, NC (US); Richard VENDITTI, Raleigh, NC (US)

(73) Assignees: North Carolina State University, Raleigh, NC (US); University of Surrey, Guildford (GB)

(21) Appl. No.: 18/874,974

(22) PCT Filed: Jun. 13, 2023
(86) PCT No.: PCT/GB2023/051538

§ 371 Date: Dec. 13, 2024

(30) Foreign Application Priority Data
Jun. 14, 2022 (GB) 2208681.3

(51) Int. Cl. C01B 32/184; B01J 6/00; B01J 21/04; B01J 23/755; B01J 35/30; B01J 37/02; B01J 37/08; B09B 3/40; B09B 101/85; C01B 3/02; C01B 32/205

(52) U.S. Cl. CPC C01B 32/184; B01J 6/008; B01J 21/04; B01J 23/755; B01J 35/394; B01J 37/0203; B01J 37/0236; B01J 37/088; B09B 3/40; C01B 3/02; C01B 32/205; B09B 2101/85; C01P 2002/82; C01P 2002/85; C01P 2002/88; C01P 2004/03; C01P 2004/04

(57) ABSTRACT

The invention relates to textile fibres, and particularly, although not exclusively, to textile microfibres and/or textile nanofibres, and their conversion into carbon nanomaterials. The invention extends to methods for converting non-biodegradable textile micro- and nanofibres and micro- and nanoplastics into harmless, non-toxic and/or biodegradable/biocompatible end-products, and encompasses apparatus and/or reactors used to perform these methods.

The present invention relates to textile fibres, and particularly, although not exclusively, to textile microfibres and/or textile nanofibres, and their conversion into carbon nanomaterials. The invention extends to methods for converting non-biodegradable textile micro- and nanofibres and micro- and nanoplastics into harmless, non-toxic and/or biodegradable/biocompatible end-products, and encompasses apparatus and/or reactors used to perform these methods.

A textile is a material made by weaving, knitting, felting or bonding together (through mechanical, thermal or chemical treatment) thread-like fibres, and is generally used in clothing. The characteristics of a textile depend on the type of fibres used and the treatment applied to them. There are three primary types of textile: (i) natural textiles, which are obtained from renewable resources, such as cotton fibre (cellulosic) and wool (protein bases); (ii) synthetic textiles, which are mostly derived from non-renewable petrochemical resources, such as polyester and nylon and significantly contribute to micro/nano plastic pollution; and (iii) semi-synthetic or regenerated textiles, which are produced from dissolving cellulose from wood and other sources to spin filament cellulose fibres. These latter textiles have different names depending on the process and solvent used to produce them, such as Rayon, Lyocell, Tencel, etc.).

Plastics have become an increasing present aspect in our daily lives and activities due to their dexterity and diversity, as well as being lightweight and relatively inexpensive to produce. In addition to the manufacture of everyday items, such as clothing and cosmetics, plastics play crucial roles in constructing transportation vehicles such as automobiles and airplanes. In medicine, plastic products are critical as antiseptic and disposable containers and instruments that provide the most significant degree of hygiene. However, despite the value of plastics for today's consumers, the environmental impacts associated with plastics after-use have started to plague human society and jeopardise the ecosystem's balance.

The environmental and health consequences of plastics are currently poorly understood. Environmental problems include the entrapment and destruction of habitat for wildlife, hazard of ingestion, and plastic-facilitated transport of organisms to new ecosystems. Human exposure to plastic pollution affect the respiratory, circulatory, and lymphatic systems, and build-up can occur in the liver, kidney, and gut. Plastic particle transport and deposition in the human body have a detrimental effect on the endocrine system, most notably causing endocrine disruption. Carcinogenicity and endocrine disruption can occur when certain polymers and their associated additives are inhaled or ingested for an extended time. Plastics have been shown to have reproductive consequences including breast cancer, prostate cancer, decreased sperm count, ovarian cancer, and overall impaired foetal development. Moreover, consumption may result in metabolic disease, bladder cancer, large bowel cancer, diabetes, liver disease, and more.

Incidentally, most plastics disposed of eventually degrade under weathering and ageing conditions into micro and nano plastics. Micro and nano plastics have gained increased interest in recent years due to their widespread presence in alarmingly large amounts and their possible detrimental effects on animals, humans and ecosystems. Currently, micro and nano plastics are divided according to their origin into primary and secondary micro and nano plastics. Due to their small size and large surface-to-volume ratio, micro and nano plastics are susceptible to absorb and accumulate pollutants and have been accumulated in all types of organisms by the alimentary or respiratory system, causing toxicity across the food chain.

Inhalation, ingestion, and cutaneous absorption of micro and nano plastics have been identified as the three basic exposure modes. Respiratory-related disorders have been epidemiologically associated with inhaled polymeric particles, including nasal cavity cancer, airway impaction, respiratory disease, lung cancer, and lung deposition. Micro and nano plastics ingested through food products may have neurological and psychological consequences. Macro, micro and nano plastics used on the skin are primarily associated with irritation. The consequences on these systems may be profound with chronic exposure; nevertheless, a lot remains unknown about the implications on the human population.

Micro and nano plastic contamination in the environment is classified by source as primary and secondary. Primary micro/nano plastics are purposefully produced as microscopic particles and are directly released to the environment by sewage spills or home and industrial effluents. Primary micro and nano plastics can be composed of plastic pellets, nurdles, powders and fibres used as personal care and cleaning products additives or industrial materials. These particles have rounded or amorphous shapes. For example, microbeads can come from facial scrubs; artificial microspheres are used in cosmetics and detergents and artificial resin pellets are used as raw materials for industrial purposes. Secondary micro and nano plastics arise from the degradation of larger plastic pieces. The disintegration of these polymers is driven by UV radiation, thermal aging, bio-film growth, and oxidation. Degradation is classified as photo-degradation, thermal degradation, biological degradation, and thermo-oxidative degradation. These micro and nano plastics are produced mainly by breaking down plastic items extensively utilised in packaging, construction, agricultural, transportation, textiles and household products.

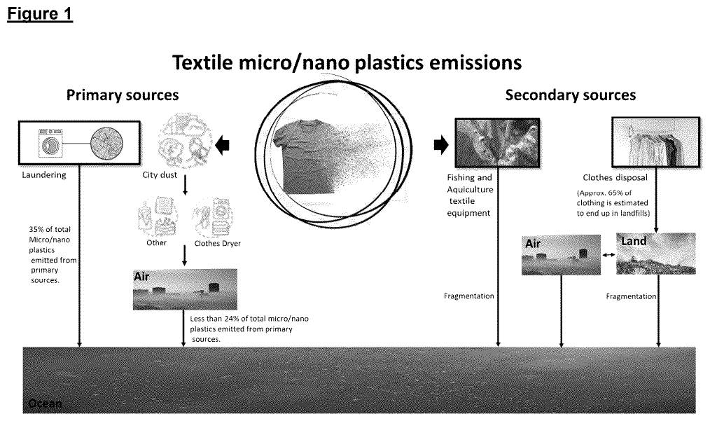

Careful considerations should be paid to one of the main sources of micro- and nanoplastic generation, namely, textile fibres, schematically illustrated in FIG. 1, which are also known as microfibres or nanofibres. Micro- and nanoplastics derived from laundering make up 35% of the total micro/nanoplastics emitted to the ocean from primary sources. However, there are other textile micro- and nanoplastics emissions to the air and soil that end indirectly into the ocean that are worth considering (see FIG. 1). In addition, it is necessary to consider micro- and nanofibres emitted to the air in the form of dust from the utilization of clothing and emission of particles from clothing dryers. These micro and nano fibres will travel through the air into the ocean and the human respiratory systems.

From secondary sources, plastic items that exceed the five-millimetre scale and enter the environment are known to deteriorate further, possibly producing micro and nano plastics. This is true for fishing and aquaculture equipment, and sanitary items and geotextiles. Additionally, landfilling of synthetic clothes is another significant source of micro and fibres. Fast fashion's disposable nature and throwaway culture have created a severe environmental, social, and economic crisis. According to the American Apparel and Footwear Association (AAFA), more than sixteen million tons of textile waste were created in the United States in 2015, with just 15% recycled, 19% percent burned for energy recovery, and the remainder (66%) thrown into landfills. Synthetic Polymer-based clothing is estimate to take 200 years to degrade in a landfill and first they will fragmentise into micro- and nanofibres.

Currently, several plastic waste valorisation approaches use liquefaction, gasification, and/or pyrolysis. Some novel technologies are also being explored for plastic upcycling, such as hydrothermal carbonisation, microwave-assisted conversion, plasma-assisted conversion, and photo-reforming.

However, there are no conversion technologies available in the market specifically designed for textile microfibres and nanofibres. The main pathways investigated for bulk plastic waste valorisation are biochemical degradation of plastics and thermochemical processing. The biochemical approach breaks the polymers into monomers and oligomers by enzymes but are typically only effective for cellulose and other natural polymer products. The thermochemical approach is based on converting the polymers into a mix of products consisting of gas, oil, and char/tar. Nevertheless, none of these approaches result in high value, biodegradable, environmentally friendly and safe products.

There is, therefore, a pressing need to provide novel and effective methods for converting textile microfibres and nanofibres into high value, biodegradable and/or amorphous/biocompatible, and/or useful end-products.

Accordingly, in a first aspect of the invention, there is provided a method for converting a textile microfibre and/or textile nanofibre into a carbon nanomaterial, the method comprising thermally cracking a textile microfibre and/or textile nanofibre under conditions that are suitable to convert the textile microfibre and/or textile nanofibre into a carbon nanomaterial.

Advantageously, the method of the invention effectively converts the textile micro- and nanofibres to high-value carbon products (i.e. a carbon nanomaterial) and, in some embodiments, one or more gases comprising primarily hydrogen, which display minimal environmental impact and no carbon emission when used as an energy source. Surprisingly, the method of the invention is able to achieve both solid-to-solid transformation of the fibre waste, as well as selectively producing high value products from intermediate gas or liquid phase species. The inventors believe that this may be energy saving because of the micro/nanostructured nature of the starting material. It is also surprisingly possible to process mixed fibre feedstocks in a reactive separation method because synthetic fibres behave very differently compared to natural fibres, making it possible to control access to catalytic sites by different reactors in a mixed fibre waste feedstock.

Preferably, the method of the invention comprises thermally cracking a textile microfibre and/or textile nanofibre which is of a natural, synthetic or semi-synthetic origin. Textile or garment finishing and treatment procedures (such as dyeing) can negatively affect the biodegradation of natural fibres. Furthermore, natural fibres are frequently blending with synthetic or semi-synthetic textile fabrics or mixed in the wash, and so the method of the invention can be applied effectively to thermally cracking a natural textile microfibre and/or textile nanofibre. However, more preferably the method comprises thermally cracking a synthetic or semi-synthetic textile microfibre and/or textile nanofibre. Advantageously, the method enables the use of a micro/nano fibre feedstock to take advantage of improved conversion efficiency due to the existing micro-nanostructure, as well as the well-defined characteristics of synthetic vs natural fibres to control product formation.

The textile microfibre and/or textile nanofibre may be obtained from any of the textiles in Table 1 below:

TABLE 1
Possible textiles from which micro- and/or
nanofibres of the invention can be derived
Textile fibres

| Animal | Natural | Synthetic polymers | Natural polymers |
|---|---|---|---|
| Alpaca | Coir | Acrylic | Acetate |
| Angora | Cotton | Aramid | Cupro |
| Camel hair | Flax | Elastane | Elastodiene |
| Cashgora | Hemp | Modacrylic | Metal fibre |
| Cashmere | Jute | Nylon | Modal |
| Guanaco | Kapok | Polyacrylonitrile | Lyocell |
| Horsehair | Linen | Polyamide | Triacetate |
| Llama | Pina | Polyester | Viscose |
| Mohair | Raffia | Polyethylene | Tencel |
| Silk | Ramie | Polypropylene | |
| Vicuna | Sisal | Polytetrafluoroethylene | |
| Wool | | Polyurethane | |
| | | Polyvinyl chloride (PVC) | |
| | | Polyethylene terephthalate | |
| | | Vinyl | |

In a preferred embodiment, the textile microfibre and/or textile nanofibre may be cotton or polyethylene terephthalate (PET).

In a most preferred embodiment, the textile microfibre and/or textile nanofibre is textile waste, which may have been collected from washing machines' filters (referred to herein as “hard textile waste”) and/or dryers' filters (referred to herein as “fluffy textile waste”).

The textile microfibre and/or textile nanofibre may be naturally formed, knitted, woven, non-woven, felted, or bonded together, preferably through mechanical, thermal or chemical treatment. The textile microfibre and/or textile nanofibre may comprise a plastics material.

“Microfibres” (or “microfibres”) and/or “nanofibres” (or “nanofibres”) are used interchangeably with “microplastics” and/or “nanoplastics” and have the same meaning in the context of the present invention.

The diameter may be measured by sieving, and the diameter or length can be measured by optical measurement, such as a fibre quality analyser, which optically analyses the dimensions (e.g. diameter and/or length) of fibres. The textile microfibre and/or textile nanofibre may have an average diameter or length of between 0.1 μm and 5 mm, between 0.1 μm and 4 mm, between 0.1 μm and 3 mm, between 0.1 μm and 2 mm.

The textile microfibre and/or textile nanofibre may have an average diameter or length of less than 5 mm, 4 mm or 3 mm. Preferably, the textile microfibre and/or textile nanofibre has an average diameter or length of less than 2 mm or 1 mm. Preferably, the textile microfibre and/or textile nanofibre has an average diameter or length of less than 750 μm, 500 μm, 250 μm, or less than 150 μm. Preferably, the textile microfibre and/or textile nanofibre has an average diameter of less than 100 μm, 75 μm, 50 μm, or less than 35 μm.

The textile microfibre and/or textile nanofibre may have an average diameter or length of between about 0.01 and 1 mm, between about 0.01 and 0.9 mm, between about 0.01 and 0.8 mm, between about 0.01 and 0.7 mm, between about 0.01 and 0.6 mm, or between about 0.01 and 0.5 mm. The textile microfibre and/or textile nanofibre may have an average diameter or length of between about between about 0.02 and 1 mm, between about 0.02 and 0.75 mm, or between about 0.02 and 0.5 mm. The textile microfibre and/or textile nanofibre may have an average diameter or length of between between about 0.02 and 0.9 mm, between about 0.02 and 0.8 mm, between about 0.03 and 0.7 mm, between about 0.03 and 0.6 mm, or between about 0.04 and 0.5 mm.

The textile microfibre preferably has an average diameter or length that is less than 10 μm, 9 μm, 8 μm, 7 μm, 6 μm or 5 μm. The textile microfibre preferably has an average diameter or length that is less than 4 μm, 3 μm, 2 μm, or 1 μm.

The textile nanofibre preferably has an average diameter or length that is between 1 nm and 1000 nm, or between 5 nm and 900 nm, or between 10 nm and 800 nm. The textile nanofibre preferably has an average diameter or length that is between 20 nm and 700 nm, or between 30 nm and 600 nm, or between 50 nm and 500 nm.

The textile microfibre and/or textile nanofibre may have an average length of between 0.01 mm and 0.5 mm, or between 0.02 mm and 0.3 mm, or between 0.05 mm and 0.15 mm.

The textile microfibre and/or textile nanofibre may have an average diameter of between 1 and 100 μm, or between 1 and 75 μm, or between 1 and 50 μm, or between 1 and 40 μm, or between 6 and 36 μm.

Surprisingly, the inventors have demonstrated that using thermal degradation to upcycle textiles micro- and/or nanofibres from different origins, particularly pyrolysis and hydrothermal carbonisation, results in significant quantities of hydrogen (H2) and high value nanostructured carbon being produced. Previous attempts to upcycle bulk textiles have been limited to thermochemical conversion of natural polymers only and aimed at producing gas, oil, and char/tar, and have not investigated the upcycling of micro- and/or nanofibres obtained from washing. However, char/tar commonly includes carcinogenic Polynuclear Aromatic Hydrocarbons (PAH) and so poses a considerable health threat.

Degradation can refer to a sequence of chemical events that result in the breakdown of the structures of plastic polymers, and can include solid-to-solid transformations as well as the intermediate formation of liquid or gas phases species that then react to form products. “Thermal cracking” or “cracking” can refer to a process that capitalises on heat and pressure to break large hydrocarbon molecules into smaller, light molecules. “Thermal cracking” or “cracking” can also refer to a process in which inert large hydrocarbon molecules thermally react with water under specific temperature and pressure conditions, in order to form smaller, light molecules.

In one embodiment, the thermal cracking of the textile microfibre and/or textile nanofibre comprises pyrolysis in order to achieve thermal cracking.

Pyrolysis is a thermochemical conversion process that is commonly used to produce liquid hydrocarbon oils, char, and gas due to the thermal decomposition of organic reactants under an inert atmosphere. The distribution of the products is highly dependent on the reaction temperature, heating rate, residence time, and reactor type. Pyrolysis fluidised bed reactors are often used because of their better heat and mass transmission capabilities, resulting in increased thermal cracking and high oil yields.

Typically, pyrolysis produces oil that can be upgraded for use as fuel in vehicle engines and power plants or as feedstock to produce valuable chemicals. Pyrolysis further produces char as a solid product. Dehydration, deamination, decarboxylation, and dehydrogenation of organics during pyrolysis and gasification result in the creation of aromatic char.

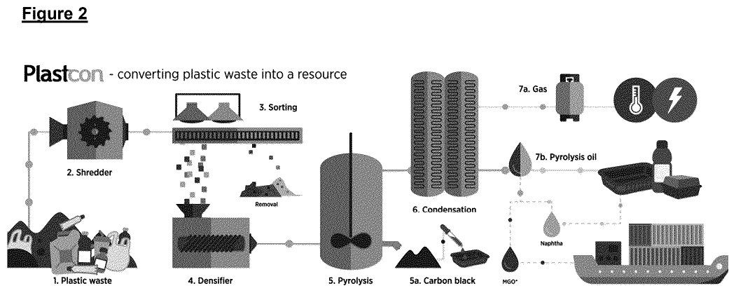

An example of industrial ventures targeting plastics conversion into carbon black has been developed by Makeen energy. The schematic process of converting plastic waste via pyrolysis is shown in FIG. 2. The process named “Plastcon” employs physical and chemical separation of plastics, followed by chemical transformation via pyrolysis. Plastcon processes bulk plastic waste from both households and industries. The resulting carbon black is useful for the manufacture of other plastic materials. It is important to consider the entire lifecycle of the end products before converting plastic wastes into products that may be more harmful to the environment.

However, there is, to date, no successful report of the use of pyrolysis to convert textile micro- and/or nanofibres into carbon nanomaterials as in the methods described herein. The inventors have surprisingly observed evidence of nanostructuring of the original micro- and non-fibres, thereby indicating a direct solid-to-solid transformation to potentially useful final products. They have, therefore, successfully optimised pyrolysis processes targeting specifically textile micro- and/or nanofibres that surprisingly yielded higher quality and quantities of carbon nanomaterials.

The pyrolysis reaction may be batch, fed-batch or continuous. The pyrolysis reaction may be carried out in a one-stage or multi-stage reactor, which may be a fixed bed or fluidised reactor. Preferably, however, the reaction is carried out in a one-stage fixed bed reactor for dry feeds or in a batch hydrothermal reactor for wet feedstocks. The advantages of having a fixed bed reactor include reduced energy requirement compared to fluidised beds, and ease of construction and operation.

The pyrolysis reaction may be performed at a temperature range of between 100° C. and 1000° C. Preferably, pyrolysis reaction is performed at a temperature range of between 20° and 900° C., between 300 and 800° C., between 40° and 700° C., or between 450 and 600° C. Preferably, pyrolysis reaction is performed at a temperature range of between 46° and 550° C., between 47° and 540° C., between 48° and 530° C., or between 49° and 520° C. Preferably, pyrolysis reaction is performed at a temperature range of between 491 and 510° C., between 492 and 509° C., between 493 and 508° C., or between 493 and 507° C. Preferably, pyrolysis reaction is performed at a temperature range of between 494 and 506° C., between 495 and 505° C., between 496 and 504° C., or between 497 and 504° C. Preferably, pyrolysis reaction is performed at a temperature range of between 498 and 503° C., between 499 and 502° C., or between 499 and 501° C., or at about 500° C.

Preferably, the pyrolysis reaction is performed at a temperature less than 1000° C., 900° C., 800° C., 700° C., 600° C., or less than 550° C. Preferably, the pyrolysis reaction is performed at a temperature greater than 100° C., 200° C., 300° C., 400° C., or greater than 450° C.

Preferably, the pyrolysis reaction is performed at a temperature less than 525° C., 500° C., 475° C., 450° C., 425° C., or less than 400° C. Preferably, the pyrolysis reaction is performed at a temperature greater than 250° C., 275° C., 300° C., 325° C., or greater than 350° C.

The pyrolysis reaction may be performed such that it has 1-200 minutes of residence time. Preferably, the pyrolysis reaction has a residence time of between 1 and 175 minutes, 1 and 150 minutes, 1 and 125 minutes, 1 and 100 minutes, 1 and 75 minutes, 1 and 50 minutes, or between 1 and 25 minutes. Preferably, the pyrolysis reaction has a residence time of between 25 and 200 minutes, 25 and 175 minutes, 25 and 150 minutes, 25 and 125 minutes, 25 and 100 minutes, 25 and 75 minutes, or 25 and 50 minutes.

The pyrolysis reaction may be performed in a closed environment, in a vacuum environment, or at atmospheric pressure under inert gas (such as nitrogen) or carbonising (such as carbon dioxide) environment. Preferably, the pyrolysis reaction is performed at atmospheric pressure as this is more efficient in terms of energy consumption.

The pyrolysis reaction may be performed with a carrier gas, which is used to maintain an inert or cabonising atmosphere inside the reaction, thus preventing combustion of the feed. The carrier gas may be an inert/noble gas or carbon dioxide, or a mixture thereof. The inert/noble gas may be selected from a group consisting of helium, neon, and argon, or a combination thereof. Other non-noble, but inert or carbonising, gases can also be used. Preferably, the carrier gas is argon or nitrogen.

In one embodiment, the pyrolysis reaction may be performed in the absence of a catalyst, i.e. non-catalytic pyrolysis. Alternatively, in another embodiment, the pyrolysis reaction may be performed in the presence of a catalyst, i.e. catalytic pyrolysis. The use of a catalyst can increase the thermochemical conversion's energy efficiency, stimulating focused reactions, and product selectivity. In addition, the inventors have shown that the use of a non-catalytic pyrolysis can convert non-biodegradable textile microfibre and/or textile nanofibre into amorphous carbon products which are potentially harmless to living organisms. Accordingly, in embodiments in which the thermal cracking of the textile microfibre and/or textile nanofibre into a carbon nanomaterial is performed non-catalytically, more energy and residence time is required, though this is preferred if the method is used to convert harmful micro- and nano-fibre waste material to harmless carbon waste.

Accordingly, in one embodiment, the pyrolysis reaction is a non-catalytic pyrolysis.

In another embodiment, the pyrolysis reaction is a catalytic pyrolysis.

In embodiments in which the pyrolysis is a catalytic pyrolysis reaction, the catalyst may be added to the reaction before, simultaneously (i.e. mixed with), or after the textile microfibre and/or textile nanofibre and pyrolysis is initiated. Preferably, the catalyst is contacted with (and preferably mixed with) the textile microfibre and/or textile nanofibre.

The selection of a suitable catalyst can help to affect the final structure of the carbon nanomaterial end product in the methods of the invention, temperature of carbonisation, and the selectivity towards the desired gas or liquid phase products. Because of their high catalytic activity and low cost, a heterogeneous Nickel (Ni)-based catalyst is preferred.

In one embodiment, the catalyst may be a single or multi-metallic catalyst. Preferably, the catalyst is a multi-metallic catalyst. The multi-metallic catalyst may be selected from a group consisting of Ni—Mg, Ni—Fe, Ni—Mg—Al, Ni/γ-Al₂O₃, Ni/α-Al₂O₃, Fe/γ-Al₂O₃, Fe/α-Al₂O₃, and Ni—Fe/γ-Al₂O₃.

In a preferred embodiment, however, the catalyst is the bi-metallic catalyst, Ni—Fe.

The catalyst may or may not be supported by a support composition. However, preferably, in some embodiments, the catalyst is supported by a support composition.

A support composition may have a significant impact on the activity and stability of catalysts. A good support composition should have a large surface area and an appropriate pore size or distribution and strong metal-support interaction, mechanical strength, and thermal stability. The most often employed supports are metal oxides, zeolites, and activated carbon (AC). Additionally, alumina is an excellent support material due to its strong chemical and mechanical resistance, large surface area, and specific acidic characteristic [153].

The support composition may be selected from a group consisting of metal oxides, zeolites, carbons, and alumina. The support has a high surface area that enables the formation of multimetallic nanoparticles distributed in its pore structure. In some instances, the nanoparticle size will play a role in influencing the final dimensions of carbon nanomaterials formed from textile microfibres and nanofibres.

Catalyst systems may also need to be modified for specific polymers. Certain compounds included in plastic waste may obstruct catalytic thermochemical conversion processes. Catalysts for the thermochemical conversion of plastic waste should be resistant to air, moisture, and organic pollutants and effective in heterogeneous combinations.

For supported metal catalysts, sintering of metals is a major issue at elevated temperature and/or hydrothermal operating conditions, resulting in a considerable loss of active sites/surfaces. This is primarily caused by Ostwald ripening, metal migration, and coalescence. Thus, preferably the supported metal catalyst has a high metal dispersion, a homogeneous metal cluster/particle size, and/or strong metal-support contact to minimize metal mobility and sintering. An additional challenge for catalyst design is to minimise coke formation on the active sites and targeting structured carbon nanomaterial formation instead.

Catalyst composition will determine the relative rates of cracking the initial polymers and graphitisation of the carbon deposited. Catalyst composition is also important for promoting hydrogen formation over other gas phase hydrocarbon products. As discussed in the Examples, the inventors have also investigated the use of hydrothermal carbonisation (HTC), another thermal cracking method for the upcycling of textile micro and nanofibres into high value nanocarbon products and hydrogen.

Hence, in another embodiment, the thermal cracking of the textile microfibre and/or textile nanofibre comprises Hydrothermal carbonisation (HTC) in order to achieve thermal cracking.

Advantageously, the inventors have surprisingly observed evidence of direct nanostructuring of solid fibres, which indicates HTC is a promising low energy input process for making nanomaterials from already nanostructured waste.

Hydrothermal carbonisation (HTC) is a relatively recent approach to treating wet organic waste. HTC (also referred to as “wet pyrolysis”) is being considered also for the valorisation of polymeric waste such as biomass. The technology itself is a way of mimicking the natural phenomena of mineralisation in aqueous media, found in natural biomass.

The use of HTC in the valorisation of polymeric waste is gaining popularity. Modern HTC applications have used various waste forms of biomass, municipal solid waste, plastics, and bulk textiles as reactants, in order to produce solid carbon, various gases (such as CO₂, CO, CH₄ and C₂H₄) and oil products.

Conventionally, product resulting from HTC processes are typically gases (or incondensable vapours), liquids rich in absorbed inorganics and unreacted components from the reactants, and solid rich in carbon akin to coal. Modern applications of HTC have used various waste forms of biomass, municipal solid waste, plastics, and bulk textiles as the reactant, aiming for solid carbon, different gases (such as CO₂, CO, CH₄ and C₂H₄), and oils products. Simulations of the process have been successful in producing solids rich in carbon with micro-porous structures, and nano-material forms. Further inspection of the integral structure of the solids indicates the existence of functional groups of oxides, sulphides, halides, based on the selection of feedstock used. Nevertheless, to date, HTC has not been used to successfully convert textile micro- and/or nanofibres into high quality carbon nanomaterials and hydrogen.

The HTC process may use a solvent in order to regulate the pressure to the desired reaction conditions inside the reactor. In the case of water or other organic solvents, these can be reactants at the same time, having a double function. Moreover, when water is utilised, it has an autocatalytic effect towards carbonisation.

Water is an excellent solvent for hydrothermal conversion processes, due to its low cost, non-toxicity, and abundance. Organic materials are hydrolysed into low molecular weight molecules during HTC. Due to the intermediate molecules' instability and reactivity, they re-polymerize into high molecular weight compounds.

Therefore, in a preferred embodiment, the HTC process uses water as a solvent. The HTC process may be batch, fed-batch or continuous. In the case of a batch hydrothermal reactor, the advantages of this reactor design are the exothermic nature of the reaction enabling lower temperature operation, as well as the ability to easily process wet feedstocks, for example, fibres collected from laundering.

HTC presents a very practical and sustainable method because of the low temperatures required, versatility of the resulting products, and its suitability for processing wet feedstocks which is essential for micro/nano fibre waste recovered aquatic environments. While HTC can operate at lower reaction temperatures than combustion, pyrolysis, and gasification, it requires highly pressurized water, to enable the hydrolysis, aromatisation, dehydration, recondensation, and decarboxylation processes resulting in the generation of high-value products. In comparison with traditional liquefaction, this method does not require high-pressure H₂ and uses water as a hydrogen donor for the reaction. The inventors have shown that using textile micro/nanofibers, as a feed stock, increases the surface area and so improves efficiency of the HTC reaction. They have observed nanostructuring of the fibres (i.e. solid to solid transformation), which means they can achieve a more energy efficient conversion by using micro/nanofiber waste.

The inventors have conducted a temperature screening analysis of hydrothermal carbonisation performed on real textile micro/nano plastic waste. Surprisingly, this study revealed that HTC performed on real textile micro/nano plastic waste under defined conditions produces carbon materials, such as carbon nanotubes, but also other types of carbon materials, such as graphite, graphene, carbon fibres, and amorphous carbon. This new application of HTC advantageously converts hazardous waste into useful products while retaining carbon in the solid phase, and thus, avoiding greenhouse gas emissions.

Furthermore, the inventors optimised the process (i.e., identified through experimentation, the optimal temperature and residence time) in order to target specific products depending on the desired outcome. For example, at a temperature of around 250° C., amorphous carbon with potential biocompatibility and harmlessness are formed. However, when the temperature is raised to around 300° C., carbon fibres composed of graphite are produced.

These experiments were conducted in the absence of a synthetic catalyst. However, the presence of iron and silica contamination from actual washing machines on the collected microfibres suggests the occurrence of an autocatalytic reaction. This indicates then that a catalyst may not be a pre-requisite, but its presence can facilitate and expedite the reaction.

The inventors have successfully demonstrated that it is possible to manipulate the outcome of the process solely by adjusting the temperature and pressure. This ability to control the reaction enables the production of either harmless carbon for disposal or valuable nanomaterials for profit. Additionally, the incorporation of a solid catalyst can further improve the selective production of specific carbon nanomaterials, such as nanotubes.

Preferably, the HTC reaction may be performed at a temperature range of between 50° C. and 650° C. Preferably, the HTC reaction is performed at a temperature range of between 100 and 600° C., between 15° and 550° C., between 20° and 500° C., or between 25° and 450° C. Preferably, HTC reaction is performed at a temperature range of between 30° and 440° C., between 32° and 430° C., between 33° and 420° C., or between 34° and 410° C., or between 35° and 400° C.

In a preferred embodiment, the HTC reaction is performed at a temperature range of between 150° C. and 350° C., more preferably between 175° C. and 325° C., and most preferably between 195° C. and 305° C.

Preferably, the HTC reaction is performed at a temperature range of between 150° C. and 250° C., more preferably between 175° C. and 225° C., and most preferably between 190° C. and 210° C. Preferably, the HTC reaction is performed at a temperature of about 200° C.

Preferably, the HTC reaction is performed at a temperature range of between 200° C. and 300° C., more preferably between 225° C. and 275° C., and most preferably between 240° C. and 260° C. Preferably, the HTC reaction is performed at a temperature of about 250° C.

Preferably, the HTC reaction is performed at a temperature range of between 250° C. and 350° C., more preferably between 275° C. and 325° C., and most preferably between 290° C. and 310° C. Preferably, the HTC reaction is performed at a temperature of about 300° C.

The HTC reaction may be performed such that it has a residence time of between 15 minutes and 24 hours. Preferably, the HTC reaction has a residence time of between 30 minutes and 23 hours, 1 and 22 hours, 2 and 21 hours, 3 and 20 hours, 4 and 19 hours, 5 and 18 hours, or 6 and 17 hours. Preferably, the HTC reaction has a residence time of between 7 and 16 hours, 8 and 16 hours, 9 and 15 hours, 10 and 14 hours, 11 and 13 hours, or about 12 hours.

In a preferred embodiment, the HTC reaction is performed such that it has a residence time of between 1 hour to 8 hours. More preferably, the HTC reaction is performed such that it has a residence time of 1 hour, 4 hours, and/or 8 hours.

The HTC reaction may be performed at a pressure which may vary depending on the temperature. For example, a pressure of 22 bar may be used at 200° C., while a pressure of more than 99 bar may be used at 350° C. Accordingly, in one embodiment of the invention, the HTC reaction may be performed at a pressure of between atmospheric pressure and 200 bar, or between 5 bar and 200 bar. Preferably, the HTC pressure is performed at pressure of between 15 and 150 bar, 20 and 150 bar, 30 and 150 bar, or 40 and 150 bar.

The HTC pressure is performed at a pressure of between 20 and 100 bar. Most preferably the HTC pressure is performed at a pressure of 20, 40 and/or 99 bar.

In one preferred embodiment, the HTC reaction is carried out at a temperature of between about 150° C. and 250° C. (preferably 200° C.), at a pressure of between about 5 and 30 bar (preferably 20 bar), and with a residence time of at least one hour.

In one preferred embodiment, the HTC reaction is carried out at a temperature of about 200° C. and 300° C. (preferably 250° C.), at a pressure of between about 30 and 50 bar (preferably 40 bar), and with a residence time of at least one hour.

In one preferred embodiment, the HTC reaction is carried out at a temperature of about 250° C. and 350° C. (preferably 300° C.), at a pressure of between about 90 and 110 bar (preferably 99 bar), and with a residence time of at least one hour.

The method may comprise the use of a purging gas during the HTC process to purge the reactor of any air which may be present. The purging gas may be an inert gas, such as nitrogen or argon.

In a preferred embodiment, however, the purging gas is nitrogen.

The HTC reaction may be run with or without a catalyst, i.e., catalytic HTC or non-catalytic HTC, respectively.

Accordingly, in one embodiment, the HTC reaction may comprise a non-catalytic HTC reaction. The inventors have shown that the use of a non-catalytic HTC reaction results in the conversion of non-biodegradable textile microfibre and/or textile nanofibres into amorphous/biocompatible carbon nanomaterial products.

Preferably, when real textile waste is used as the starting material, the HTC reaction is a non-catalytic HTC reaction.

In another embodiment, the HTC reaction may be a catalytic HTC reaction.

In embodiments where the HTC is a catalytic HTC reaction, the catalyst may be loaded to the reactor before, simultaneously (i.e. mixed with), or after the textile micro/nanofibre. Preferably, the catalyst is loaded simultaneously with the textile micro/nanofibre.

The catalyst used for catalytic HTC reaction may be as described herein with respect to the pyrolytic reaction. Therefore, in one embodiment, the catalyst may be a single or multi-metallic catalyst. Preferably, the catalyst is a multi-metallic catalyst. The multi-metallic catalyst may be selected from a group consisting of Ni—Mg, Ni—Fe, Ni—Mg—Al, Ni/γ-Al₂O₃, Ni/α-Al₂O₃, Fe/γ-Al₂O₃, Fe/α-Al₂O₃, and Ni—Fe/γ-Al₂O₃.

In a preferred embodiment, however, the catalyst is the bi-metallic catalyst, Ni—Fe. The catalyst may be supported on a support composition.

As shown in FIG. 3, several different products may be produced with the methods of the invention, for example pyrolysis or hydrothermal carbonisation. In particular and more importantly, two key products are produced using with the two methods described herein, i.e. high value carbon and hydrogen, the methods enable a greater yield and a higher quality of these end-products.

Carbon nanomaterials, such as CNTs, carbon nanofibres (CNFs), carbon nanosheets (CNS), cup-stacked carbon nanotubes (CS-CNT), and hollow carbon spheres (HCS) have been generated from plastic waste. However, to date, it has not been possible to generate carbon nanomaterials from textile micro- and nanofibres.

Therefore, in a preferred embodiment, the carbon nanomaterial produced by the method of the invention may be selected from a group consisting of carbon nanofibres (CNFs), carbon nanosheets (CNS), carbon nanotubes (CNT), cup-stacked carbon nanotubes (CS-CNT), hollow carbon spheres (HCS), paracrystalline carbon nanoparticles, graphite, or graphene.

These carbon nanomaterials have a wide range of utilities, including in batteries, solar cells, medical devices, and they may also be sequestered for subsequent uses. Carbon nanotubes (CNTs) have attracted significant interest because of their thermal stability, excellent thermal and electrical conductivity, great mechanical strength, high elasticity, excellent tensile strength, flexibility, and semiconducting properties. CNTs have found uses in the automobile sector, where they are employed as conductive polymers and for plastic reinforcing, as catalytic materials, etc. . . . Furthermore, CNTs are used as catalysts or catalytic supports in various essential scientific disciplines (e.g., energy production and storage, electronics, and medicine). Chemical vapour deposition of synthetic hydrocarbons is the most popular technique for producing CNTs.

Carbon nanotubes consist of carbon-bonded materials, i.e. graphene, where carbon atoms are closely organised in an atomic-scale honeycomb (hexagonal) pattern. CNTs are cylinders fabricated of rolled-up graphene sheets, and they offer a potentially substantial source of revenue for upcycling schemes. Various types of single-walled (SWCNTs), double-walled (DWCNTs), as well as multi-walled carbon nanotubes (MWCNTs), are envisaged as being produced by the carbon nanomaterial products from the methods described herein.

Most established methods to synthesise CNTs employ a vacuum or hydrocarbon process gases at atmospheric pressure. However, these methods currently used to produce CNTs are energy-intensive, non-environmentally friendly due to the gas emissions, and costly. Therefore, the prices of the materials are very high. Therefore, carbon nanomaterial (CNM) manufacturing methods that are more sustainable and cost-effective are of significant business interest. Advantageously, the methods described herein address these issues.

In one embodiment, the method produces hydrogen in addition to the carbon nanomaterial.

Advantageously, hydrogen gas (H₂) plays an important role in our current energy landscape, and its use will become increasingly prevalent in the future as an energy carrier. Its application is found in the petrochemical industry, semiconductor industry, as a coolant, energy carrier, and rocket propellant. All of the thermal conversion techniques for textile micro- and nanofibres upcycling described herein enable the generation of H₂, whereas chemical upcycling of polymers has focused on producing only hydrocarbon products. Devising processes for selective hydrogen production necessitates the development of robust catalysts with stable activity and mechanical integrity under various potential operating conditions and reactor geometries as described above.

Presently, due to rising greenhouse gas emissions and the rapid increase in the use of renewable energy sources for power production in recent years, the production of green hydrogen is set to increase massively over the following decades. Hydrogen may be used as a storage medium for renewable energy where it would be considered “green hydrogen”, balancing energy production and demand while assisting in decarbonizing the energy system, particularly in transportation and industrial heating applications.

The environmental advantages of hydrogen usage are significantly reliant on the techniques and basic sources used to produce hydrogen. Therefore, it is important to establish scalable, low emission hydrogen production technologies to reduce prices and generate hydrogen globally. Hydrogen is mostly generated using the low-cost/high environmental impact steam reforming of methane (SRM) pathway. Because steam reforming of methane is the most established and least expensive industrial technology for hydrogen generation, it produces the majority of hydrogen. Consequently, the global hydrogen production emits 900 Mt of CO₂ each year.

Accordingly, the methods disclosed therein further provide means to produce hydrogen without negatively impacting the environment. Furthermore, these methods concurrently remove damaging nanoplastic waste from the environment.

Different colours are used to differentiate the various methods of hydrogen production based on the major energy source and level of greenhouse gas (GHG) emissions [158]. At the moment, the majority of hydrogen is grey hydrogen. The grey hydrogen represents hydrogen generated without carbon collection, usage, or storage by steam reforming natural gas or coal (CCUS). The primary drawback of grey hydrogen is the large amount of CO₂ emitted during hydrogen generation, which is predicted to be around 830 Mt CO₂ per year. Blue hydrogen is hydrogen generated from a fossil fuel with carbon capture and storage. A hydrogen-producing plant currently needs just to install a CCUS device to qualify as blue hydrogen. The precise quantity that must be collected has not been specified. When applied to SRM, up to 90% collection rates were recorded, including post-combustion CO₂ capture. Blue hydrogen is now seen as a bridge technology between green hydrogen and a complete transition to green hydrogen.

Green hydrogen is hydrogen produced electrochemically from water using renewable energy sources. This kind of hydrogen is particularly valuable as we move to a more sustainable energy and transportation system. While hydrogen generation from nuclear energy is not heavily advocated in European hydrogen programs, it may become a viable option in other parts of the globe, such as China and Russia. This is sometimes called “purple hydrogen” and is produced electrochemically using electricity generated from nuclear power stations.

In contrast to the previously mentioned conventional methods, the by-product of turquoise hydrogen via methane-pyrolysis is solid carbon. The by-products can be used in subsequent production processes or may be more easily stored, resulting in a lower carbon footprint. Nonetheless, it has only recently sparked interest in producing hydrogen primarily by thermal decomposition. Pyrolysis is not yet commercially competitive against steam reforming of methane (SRM) in terms of hydrogen generation, but there are examples of large-scale commercial applications when the carbon product is sold as well. The hydrogen generated by the technologies discussed in this disclosure, can be categorized as turquoise hydrogen, it is generated by thermal decomposition of plastics and at the same time generates low emissions. This is a way to recycle or upcycle residues that nowadays are damaging to the environment and will take decades to degrade naturally. If a low emission energy source can power the process, the carbon emissions related to hydrogen production can be further reduced.

Accordingly, in one embodiment, the resulting hydrogen is turquoise hydrogen (when synthetic micro and/or nanofibres are used as feedstock) or green hydrogen (when natural micro and/or nanofibres are used as feedstock) or a combination thereof.

Low-carbon hydrogen generation technologies are essential for a decarbonised economy. Waste valorisation techniques should be developed according to a hydrogen economy vision, and the present invention meets these targets.

As described herein, the various embodiments of the methods of the first aspect convert non-biodegradable textile microfibres and/or textile nanofibres into biodegradable and/or amorphous/biocompatible carbon nanomaterial products. This is the case for both pyrolysis and thermal decarbonisation, when used in the absence of a catalyst. The inventors therefore believe that they are the first to have devised a method for converting non-biodegradable textiles into biodegradable and/or biocompatible waste.

Therefore, in a second aspect of the invention, there is provided a method of converting a non-biodegradable textile microfibre and/or textile nanofibre into biodegradable and/or biocompatible waste, the method comprising thermally cracking a textile microfibre and/or textile nanofibre under conditions that are suitable to convert the textile microfibre and/or textile nanofibre into biodegradable and/or biocompatible waste.

Advantageously, the inventors have demonstrated that using the methods disclosed herein without a catalyst convert textile micro- and nanofibres into solid carbon mass, which is readily biodegradable and/or biocompatible.

Accordingly, in one embodiment of the method, the thermal cracking of the textile microfibre and/or textile nanofibre comprises pyrolysis in order to achieve thermal cracking. Preferably, the pyrolysis is carried out in the absence of any catalyst.

In another embodiment of the method, the thermal cracking of the textile microfibre and/or textile nanofibre comprises hydrothermal carbonisation (HTC) in order to achieve thermal cracking. Preferably, the hydrothermal carbonisation is carried out in the absence of any catalyst.

Preferably, the biodegradable and/or biocompatible waste is a carbon by-product. The carbon by-product may be solid.

When the carbon by-product is a solid carbon compound, the solid carbon by-product may be amorphous or crystalline low surface area carbon.

The non-catalytic pyrolysis and non-catalytic thermal carbonisation may be performed as described herein with respect to the method of the first aspect.

In a third aspect of the invention, there is provided an apparatus for performing the method according to either the first or second aspect.

The apparatus is preferably configured to thermally crack a textile microfibre and/or textile nanofibre under conditions that are suitable to convert the textile microfibre and/or textile nanofibre into a carbon nanomaterial.

The apparatus may comprise a furnace or a heat exchanger. The apparatus may comprise a reaction vessel in which the thermal cracking reaction takes place.

The thermal cracking of the textile microfibre and/or textile nanofibre may be performed by pyrolysis. In this embodiment, the apparatus preferably comprises a fixed-bed continuous flow reactor, and optionally a condenser.

The thermal cracking of the textile microfibre and/or textile nanofibre may be performed by Hydrothermal carbonisation (HTC). In this embodiment, the apparatus preferably comprises a batch reactor with a temperature and pressure controller.

All of the features described herein (including any accompanying claims, abstract and drawings), and/or all of the steps of any method or process so disclosed, may be combined with any of the above aspects in any combination, except combinations where at least some of such features and/or steps are mutually exclusive.

For a better understanding of the invention, and to show how embodiments of the same may be carried into effect, reference will now be made, by way of example, to the accompanying Figure, in which:

FIG. 1 shows an overview of the common sources of textile microfibres and nanofibres.

FIG. 2 shows a schematic process of the conversion of plastic waste via pyrolysis, courtesy of Plastcon.

FIG. 3 shows a schematic overview of a first embodiment of the method according to the present invention, i.e. a pyrolysis process. This method may be used with or without a catalyst. When a catalyst is used, typical end products include hydrogen and other gases, carbon nanotubes and pyrolytic oil.

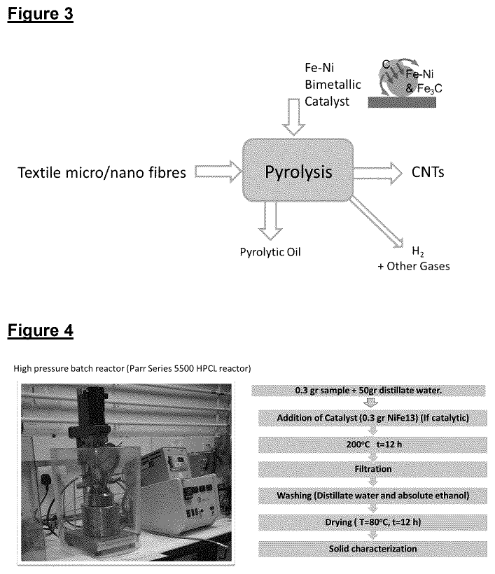

FIG. 4 shows a schematic overview of a second embodiment of the method of the invention, i.e. a hydrothermal carbonisation process. This method may also be used with or without a catalyst.

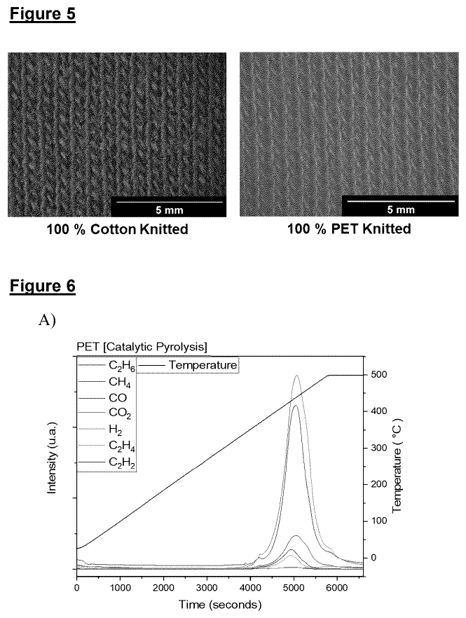

FIG. 5 shows images of textile construction.

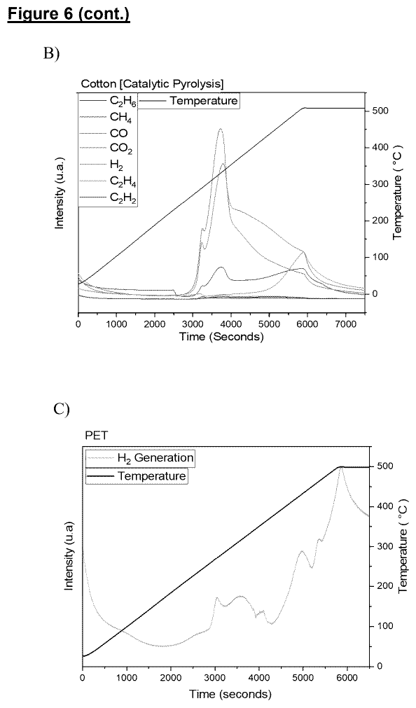

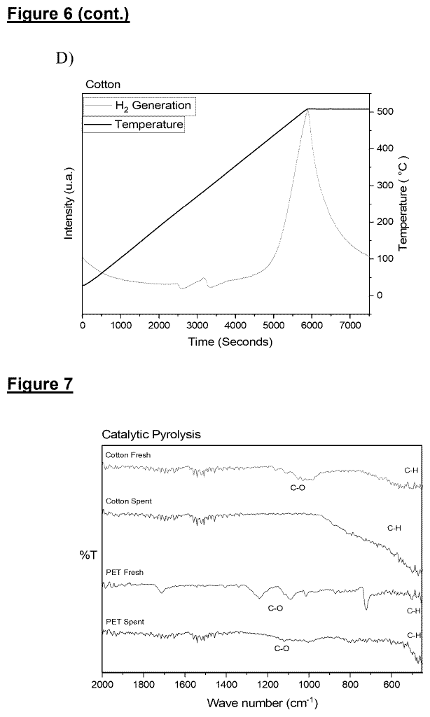

FIG. 6 shows, in plots A and B, gas releasing behaviours of the textile micro- and nanofibres during the catalytic pyrolysis process for polyethylene terephthalate (PET) or polyester micro- and nanofibres and cotton micro- and nanofibres. Plots C and D show hydrogen production during catalytic pyrolysis process from PET micro- and nanofibres and cotton micro- and nanofibres.

FIG. 7 shows the FT-IR (Fourier transform infrared) spectroscopy patterns for cotton and PET fresh/spent samples under catalytic pyrolysis.

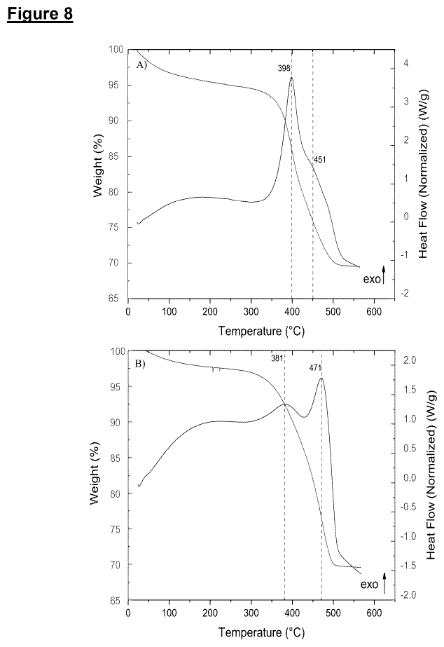

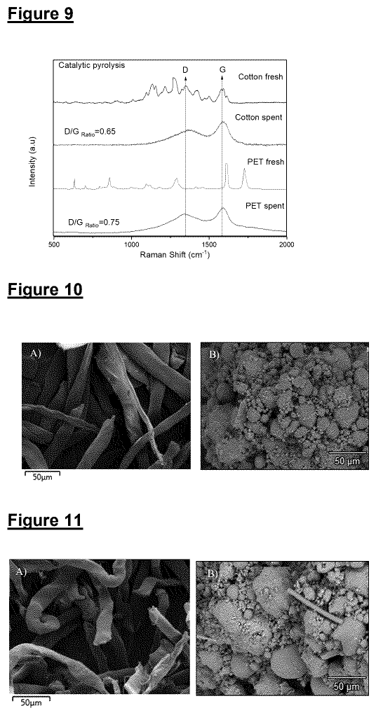

FIG. 8 shows the thermogravimetric (TGA) and differential scanning calorimetry (DSC) curves of combustion of post-pyrolysis samples in air atmosphere (5° C./min) for PET (plot A) and cotton (plot B).

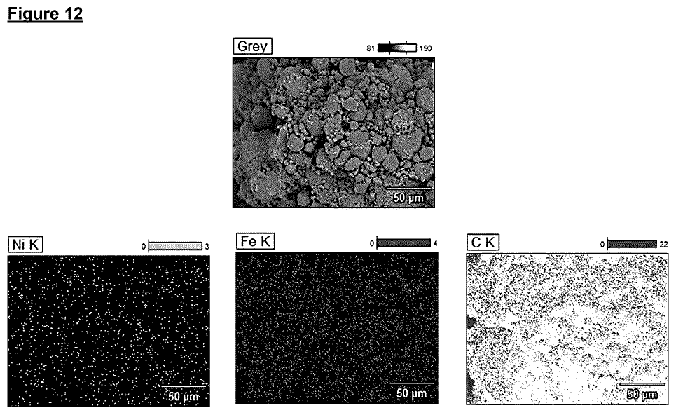

FIG. 9 shows the Raman spectra of fresh/spent cotton and PET samples under catalytic pyrolysis.

FIG. 10 shows SEM (Scanning electron microscopy) images of fresh cotton (A) and post-pyrolysis cotton (B).

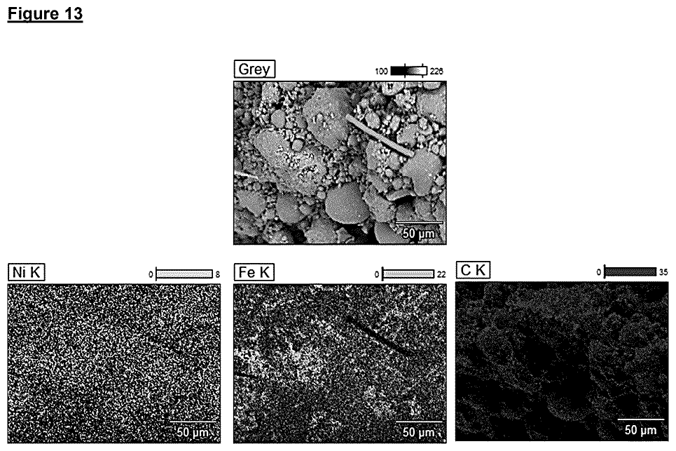

FIG. 11 shows SEM images of fresh PET (A) and post-pyrolysis PET (B).

FIG. 12 shows SEM-EDX (Scanning electron microscopy with energy dispersive X-ray spectroscopy) elemental mapping of cotton post-pyrolysis sample for Ni, Fe and C elements.

FIG. 13 shows SEM-EDX elemental mapping of PET post-pyrolysis sample for Ni, Fe and C elements.

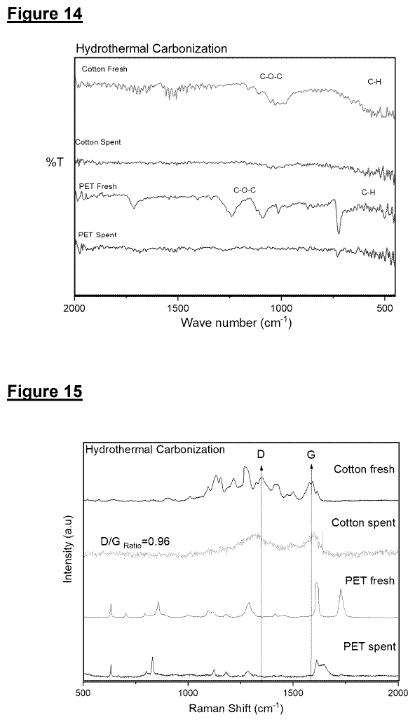

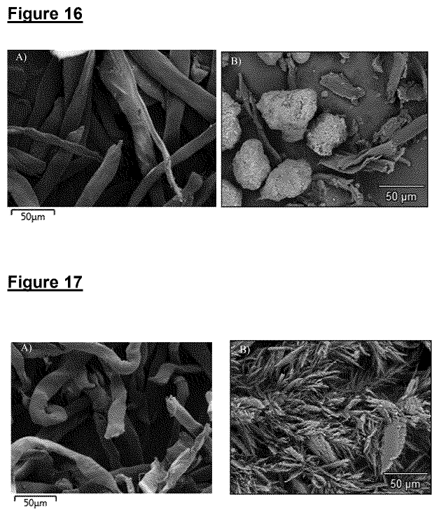

FIG. 14 shows the FT-IR patterns for cotton and PET samples pre and post reaction for hydrothermal carbonisation.

FIG. 15 shows the Raman spectra of fresh/post-reaction cotton and PET samples under catalytic hydrothermal carbonisation.

FIG. 16 shows SEM of fresh cotton (A) and post-HTC cotton (B).

FIG. 17 shows SEM images of fresh PET (A) and post-HTC PET (B).

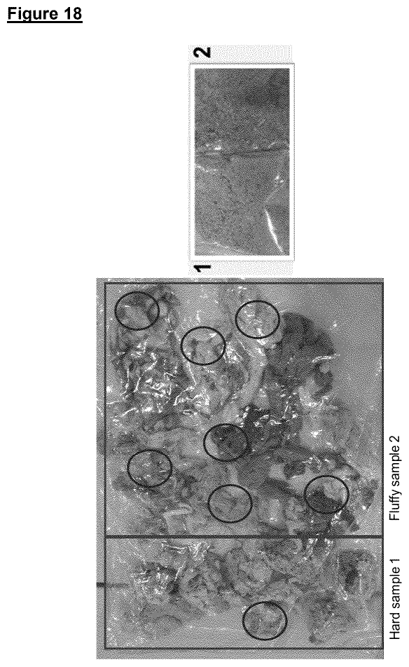

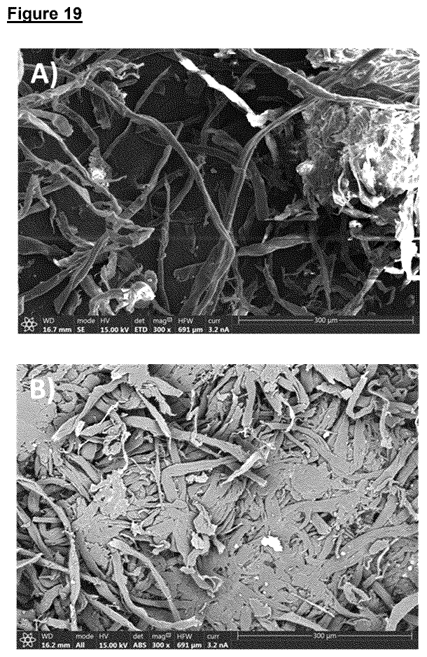

FIG. 18 shows images of exemplary real waste samples provided by Xeros company.

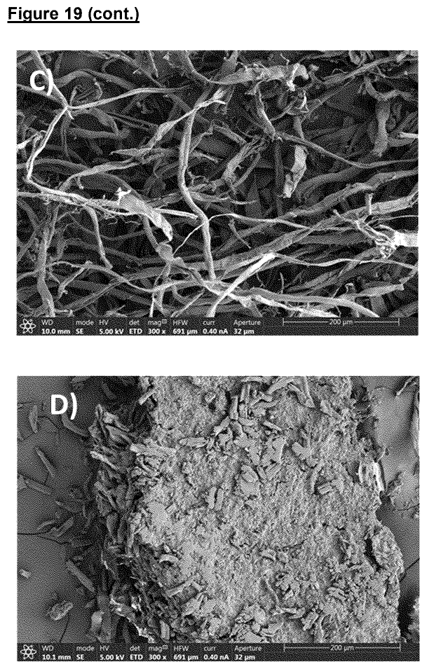

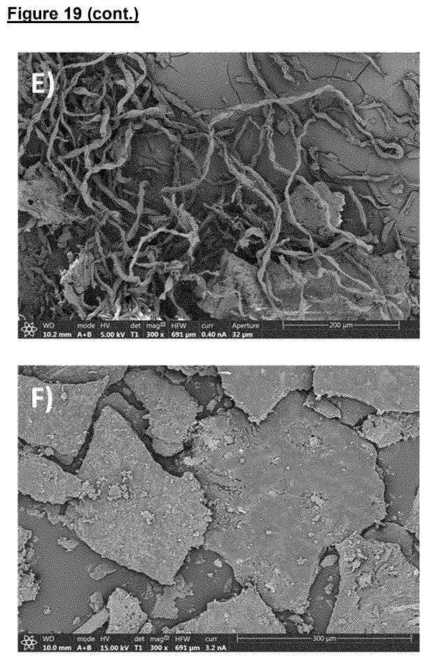

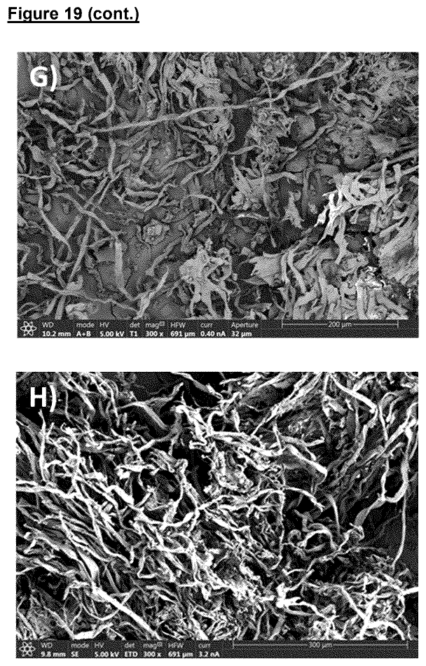

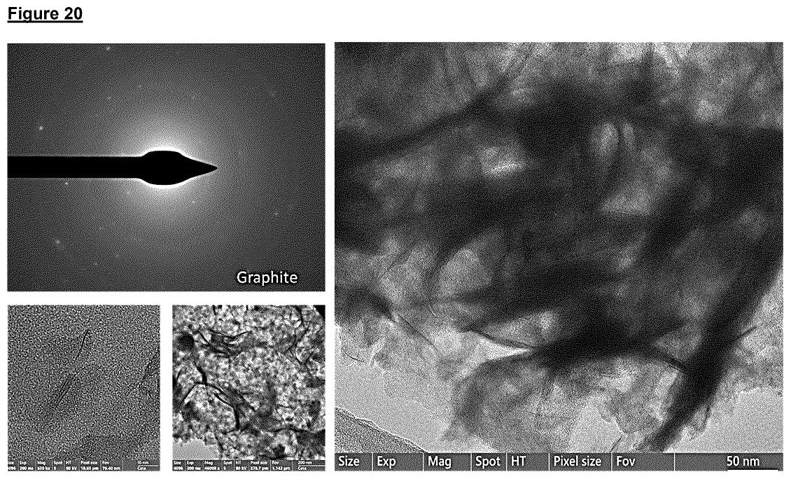

FIG. 19 shows SEM of microfibre textile wastes and products at different reaction temperatures and residence times. Panel A) shows images of the pre-reaction fluffy sample. Panel B) shows images of the pre-reaction hard sample. Panel C) shows products obtained at 200° C. for 4 hours. Panel D) shows products obtained at 200° C. for 8 hours. Panel E) shows products obtained at 250° C. for 1 hour. Panel F) shows products obtained at 250° C. for 4 hours. Panel G) shows products obtained at 300° C. for 1 hour.

FIG. 20 shows TEM images and EDX of products obtained from post-reaction textile microfibre wastes at 300° C. for 4 hours.

### EXAMPLES

The invention relates to the direct conversion of micro- and/or nanostructured waste fibres to micro- and/or nanostructured carbon (possibly including solid-to-solid transformation) as well as the conversion of micro- and/or nanofibre waste to harmless (biocompatible or biodegradable) carbon. The inventors have therefore developed and optimised thermal conversion methods (i.e., thermal cracking) that enable the conversion of non-biodegradable textile microfibres and nanofibres into high-value and high quality carbon nanomaterial products and hydrogen. In a first embodiment of the method, the inventors used cotton and PET micro- and nanofibres to optimise a catalytic and non-catalytic pyrolysis process. In a second embodiment of the method, the same starting materials were then subjected to a hydrothermal carbonisation process. Each step of these two methods was optimised in order to reach higher yields of the resultant products. After testing various catalyst combinations, the inventors have carefully selected the optimum catalyst and/or catalyst combination to use in the various processes discussed below.

Starting Materials (Textile Micro- and/or Nanofibres)

As a proof-of-concept, thermal conversion experiments were conducted using cotton a natural fibre and polyester a synthetic fibre as starting materials. These materials are commonly used in the textile industry. Interlock fabrics without finishing were provided by Cotton Incorporated. The spun yarns contained 100% cotton and 100% polyester. The weft knitted interlock construction was made on a 24-cut circular knitting machine (24 needles/inch). Spun yarns from staple fibres with a size of 40/1 Ne (English Cotton Count, 40×840 yards of one single yarn weight 1 pound) were used to knit the fabrics.

Alternatively, real textile micro/nano fibres waste were used. These highly heterogenous samples were provided by Xeros company. Two distinct textures referred to as “hard” and “fluffy” were identified, as can be seen in FIG. 18. The “hard” sample comprises agglomerated textile microfibres collected from washing machine filters and displays a homogeneous colour and texture. The “fluffy” sample consists of soft textile microfibres, collected from dryers' filters that have different colours due to textile dying.

### Example 1: Pre-Treatment of the Starting Textile Material

As a pre-treatment, the fabrics were scoured with sodium hydroxide to remove impurities from the fibres, such as wax, fats, pectin, proteins, and organic acids, and improve their wettability. Additionally, the cotton fabrics were also bleached. These fabrics were dyed with different colours (purple for cotton and pink for polyester) (FIG. 5)[97]. Tables 2, 3, and 4 summarise the chemical elemental composition and morphological characterisation of the micro- and nanofibres resulting from the pre-treatment of the textiles. Micro- and nanofibres were subsequently used in the thermal conversion experiments discussed below.

Regarding the real waste samples, seven distinct regions were identified in the “fluffy” sample and, therefore, to standardise the experiments and use a homogeneous sample, an equal amount of each of the seven regions was selected, then grinded and mixed using an endless screw. In contrast, the hard sample was considered homogeneous, and therefore, the endless screw was used to break the agglomeration.

A mixture comprising an equal amount of each of the “hard” and “fluffy” samples was used to perform the reactions.

TABLE 2
Basis weight and thickness of cotton and PET fabrics

| | Basis | | | | | |
|---|---|---|---|---|---|---|
| | Weight | Standard | | Standard | Density | Standard |
| | (g/m²) | Error | Thickness | Error | (g/m³) | Error |
| Fabrics | Mean | N = 4 | (μm) | N = 12 | Mean | N = 4 |
| 100% | 215.7 | 1.2 | 995.417 | 5.250 | 216.7 | 1.2 |
| Cotton | | | | | | |
| Knitted | | | | | | |
| 100% PET | 242.4 | 2.2 | 943.250 | 3.356 | 257.0 | 2.3 |
| Knitted | | | | | | |

TABLE 3
Mean size of microfibres

| | | | Arithmetic Mean |
|---|---|---|---|
| | | Arithmetic Mean | Width (μm) |
| | | Length (mm) | (W = 7 . . . 60 μm) |
| | Fibre | (L = 0.05 to 10 mm) | (L = 0.50 10.00 mm) |
| Sample | Count | @ 95% Confidence Level | @ 95% Confidence Level |
| 100% Cotton | 29423 | 0.329 ± 0.003 | 19.8 ± 0.110 |
| 100% | 38378 | 0.126 ± 0.001 | 19.4 ± 1.228 |
| Polyester | | | |

TABLE 4
Surface chemistry of microfibres

| Micro fibre | | | | | | | | |
|---|---|---|---|---|---|---|---|---|
| Samples | C | O | N | S | Si | Ca | | |
| 40 Mesh | (%) | (%) | (%) | (%) | (%) | (%) | C/O | Oxidation |
| 100% Cotton | 61.8 | 38.2 | 0.0 | 0.0 | 0.0 | 0.0 | 1.6 | Yes |
| 100% Polyester | 70.6 | 29.4 | 0.0 | 0.0 | 0.0 | 0.0 | 2.4 | Yes |

### Example 2: Catalyst Preparation

The bimetallic catalyst Ni—Fe was prepared with a molar ratio of 1:3, and used for the subsequent thermal conversion experiments. A wet impregnation synthesis method discussed below was chosen over other approaches not only because it requires fewer preparatory stages but also because it is commonly utilised for supported catalysts and typically resulted in active materials. The metal loading was 10% by weight and the support load was 90%, which together form the heterogeneous catalyst.

First, the necessary amounts of metal precursor (Ni(NO₃)₂·6H₂O) and Fe(NO₃)₃ 9H₂O were dissolved in ethanol and added to the support gamma Al₂O₃. After that, in order to obtain homogeneity of the suspensions, the mixture was stirred for 4 hours at room temperature using magnetic stirrer. Secondly, the excess ethanol was removed in a rotary evaporator under reduced pressure (50° C. and 150 mmbar) and the materials were dried in an oven at 80° C. for 12 hours. The last step of the method was the calcination at 800° C. (10° C./min ramp) for 3 hours.

### Example 8: Pyrolysis—Catalytic Method

The catalytic pyrolysis process of textile micro- and nanoplastics was carried out in a one-stage fixed bed reactor. The reaction system consists essentially of a quartz tube reactor with one temperature range (catalytic/non catalytic pyrolysis zone), a gas supplying system, a gaseous product condensing system, a gas cleaning system followed by a gas online and offline measurement system.

Before each reaction, the quartz reactor was loaded with 30 mg of textile micro- and/or nanofibre and 15 mg of the catalyst previously mixed together. High purity argon (99.99%) was supplied as inert gas (110 ml/min). The pyrolysis temperature was heated up from the ambient temperature to 500° C., with a 10° C./minute increment. Once the temperature of 500° C. was reached, the reaction was held at 500° C. for 30 minutes. After pyrolysis, condensable vapours were collected by a condenser. A small branch of the non-condensable gases was introduced into a mass spectrometer (MS) to monitor gas evolution online. The signals were recorded and identified on the basis of the atomic mass units of 2, 16, 26, 28, 30, 44 corresponding to the main produced gas H₂, CH₄, C₂H₂, CO+C₂H₄, C₂H₆ and CO₂, respectively, according to the molecular weights of gases.

### Example 3: Pyrolysis—Non-Catalytic Method

The non-catalytic pyrolysis process of textile micro- and nanoplastics was carried out as described in Example 2, but this time without a catalyst.

### Example 4: Hydrothermal Carbonisation (HTC)—Catalytic Method

The HTC reactions were conducted in a batch reactor (Parr Series 5500 HPCL Reactor with a 4848 Reactor Controller) using 300 mL PTFE gaskets. A quantity of 0.30 g of textile fibres, 50 g of water and 0.15 g of catalyst were loaded in a glass-lined steel vessel. To avoid any air contamination, N₂ was bubbled through the solution for 5 min under a stirring speed of 100 rpm before closing the reaction vessel. Then, the reactor was heated to the desire temperature (200° C.) and held at this temperature for 12 h under a stirring speed of 300 rpm. The pressure of the vessel was fixed according to the natural pressure generated by the solvent (water) at 22 bar during the reactions respectively. After the reaction, the spent catalyst was recovered from the liquid by filtration, followed by drying.

### Example 5: HTC—Non-Catalytic Method

The non-catalytic HTC process of textile micro- and nanoplastics was carried out as described in Example 4, but without any catalyst.

Alternatively, the HTC—non-catalytic method was performed as follows.

### Non-Catalytic HTC Reaction

The HTC reactions were conducted in a batch reactor (Parr Series 5500 HPCL Reactor with a 4848 Reactor Controller) using 300 mL PTFE gaskets. A quantity of 0.30 g of textile fibres and 50 g of water were loaded in a glass-lined steel vessel. To avoid any air contamination, N₂ was bubbled through the solution for 5 min under a stirring speed of 100 rpm before closing the reaction vessel. Then, the reactor was heated to the desire temperature (200° C., 250° C. or 300° C.) and held at this temperature for the residence time stablished (1 h, 4 h or 8 h) under a stirring speed of 300 rpm. The pressure of the vessel was fixed according to the natural pressure generated by the solvent (water) during the reactions respectively. After the reaction, the post-reaction sample was recovered from the liquid by centrifugation, followed by drying.

Following the conclusion of the HTC reaction, the post-reaction sample was collected and then subjected to the characterisation experiments described below.

### Elemental Analysis

The elemental analysis measurements were performed using a LECO TruSpec CHNS microanalyzer (TruSpec Micro Elemental Series). TruSpec Micro utilises a combination of flow-through carrier gas and individual, highly selective infrared (IR) and thermal conductivity detectors resulting in simultaneous determination of CHNS. 1-2 mg of sample was loaded in the sample holder. Several measurements were taken to calculate the error due to the heterogeneity of the sample.

Scanning Electron Microscopy (SEM) SEM was carried out on pre- and post-reaction samples by using a JEOL JSM-7100F instrument, which also had an Energy Dispersive X-ray Spectroscope (EDS) analyser. Carbon paint was used to fix the samples to the holder and gold coating was conducted to eliminate the charging effects.

### Transmission Electron Microscopy (TEM)

Information about the supported metal particles was acquired by in a JEOL 2100F field emission gun electron microscope operated at 200 kV and equipped with an Energy-Dispersive X-Ray detector, EDX. The sample was grinded to powder and a small amount was suspended in acetone solution using an ultrasonic bath. Some drops were added to the copper grid (Aname, Lacey carbon 200 mesh) and the solvent was evaporated at room temperature before introduction in the microscope. EDX-mapping analysis was performed in STEM mode with a probe size of 1 nm using the INCA x-sight (Oxford Instruments) detector.

### Results and Discussion

### Thermal Conversion Using Pyrolysis

Data on the end-product evolution and distribution were obtained using mass spectrometry analysis. Ion-current changes versus time during pyrolysis-catalytic process of textile micro- and nano-fibres with NiFe catalysts are shown in FIGS. 6A and 6B), and real-time temperature for each trial was also plotted. As the oxygen content of cotton and PET samples was very limited, 38.2% and 29.4% respectively, and oxygenic groups exist inside the polymer chains, it is suggested that oxygen-containing compounds, such as CO and CO₂, are easily released at the beginning of the reaction. In that sense, for the signal of 28 a.u, which is the superposition of C₂H₄ and CO, the first peak was due to the evolution of CO and the second peak was for the C₂H₄. It has been demonstrated that gas from only thermal cracking of bulk plastic wastes mainly consists of CH₄, and C₂H₄. Although fossil derived CH₄ and C₂H₄ have been reported to be good carbon sources for the catalytic reaction for the production of CNTs, the present experiment demonstrates that it is surprisingly effective to use a Ni—Fe catalyst for these carbon formation reactions when starting from micro- and/or nanofibre textile waste. When Ni—Fe catalysts were applied on PET and cotton textile micro- and nanofibres, H₂ was produced, with the maximum value achieved at 500° C. for both samples (see FIGS. 6C and 6D). It should be appreciated that the production of H₂ has a delay in comparison with the other gas streams produced, and this may be due to the fact that complex reactions such as catalyst redox and carbon deposition occur.

FIG. 7 shows the FT-IR patterns of the samples, in comparison to a fresh/spent sample. The patterns show that thermal treatment produced clear changes in the chemical functionalities, and therefore, the chemical composition of both samples and provides information about the functional groups formed on the material surface, which are very important for the evaluation of the degree of carbonisation.

Broad spectral bands between 3670 and 2979 cm⁻¹ may indicate the presence of surface groups such as phenol, carboxylic acids, and carboxylic acid derivatives, as well as physically adsorbed water on the surface of the material. These bands are generated by O—H stretching, but usually the signal of O—H stretching bands of carboxylic acids is intense in a wide range of the spectrum. Coupling bands between 1800 and 1900 cm−1 (C═O and C—O—C) assigned to symmetric and asymmetric stretching's for carboxylic acid derived from anhydrides, which normally appear shifted by 60 cm−1. Moreover, the broad band at around 1000-1300 cm−1 can be associated with the C—O stretching of ethers, lactones and phenols.

As confirmed by TGA measurements, the plots in FIG. 7 show a distinct reduction of C—O—R chemical functionalities, which could be due to the decomposition ethers, lactones, phenols, etc. The reduction or disappearing of these chemical functionalities can be seen in FIG. 3. In comparison with the fresh samples, the breakage of the C—O—R bonds is detected as an indication of a carbonisation process occurring during the reaction.

FIG. 8 shows the TGA and DSC (thermogravimetric analysis and differential scanning calorimetry) curves of combustion (air atmosphere) of spent samples of PET (plot A) and cotton (plot B). The curves show a distinct separation mark among two types of carbon type and moisture, both for cotton and PET feedstocks, namely:
1) under 100° C., moisture present in the sample;
2) between 10° and 400° C., low quality/amorphous carbon; and
3) from 400° C., until 600° C., high quality/nanostructured carbon.

From the TGA-DSC plot, the percentage of each species present in the sample can be calculated, combining the information relating to the weight loss and heat flow. Each positive peak in the heat flow corresponds to an exothermic reaction; due to the oxygenated atmosphere this reaction is a combustion of the different carbonaceous materials present. As can be appreciated in FIG. 8A, the TGA curve presents two different peaks of combustion, one at 398° C. considered to be a low quality or more amorphous carbon, and a second peak at 451° C. considered to be a high-quality carbon nanomaterial or more crystalline carbon. Moreover, extracting the weight percentage of each species of the total sample, approximately 70 wt % will be catalyst, 9 wt % will be considered as high-quality carbon and 17 wt % will be considered as low-quality carbon produced in the pyrolysis process performed on polyester textile nano/micro fibres which is used as the feedstock. The remaining percentage until 100% is considered as weight loss due to moisture present in the sample. In conclusion, from the total carbon materials that have been produced after the catalytic pyrolysis process, it can be determined that from PET as feedstock, approximately 35% is converted towards high quality carbon that can contain CNTs, and 65% is converted to low quality carbon, that have less economic value, but which is not harmful to the environment and can be used in other applications.

Furthermore, as it can be appreciated in FIG. 8B, the TGA curve presents two different peaks of combustion, one at 381° C. considered to be a low quality or more amorphous carbon, and a second peak at 471° C. considered to be high-quality carbon nanomaterials or more crystalline carbon. Moreover, extracting the weight percentage of each species of the total sample, approximately 69 wt % is the catalyst, 16 wt % will be considered as high-quality carbon and 11 wt % will be considered as low-quality carbon produced in the pyrolysis process performed on cotton textile nano- and microfibres as the feedstock. The remaining percentage until 100% will be considered as weight loss due to moisture present in the sample. In conclusion, from the total carbon materials that have been produced after the catalytic pyrolysis process, it can be determined that from cotton as feedstock, approximately 59% is converted towards high quality carbon that can contain CNTs, and 41% is converted to low quality carbon.

From comparing both total carbon conversions, it can be determined that using cotton as feedstock produces better quality carbon than PET (59% vs 35%). This fact can be due to the differences relating to the chemical structures of both feedstocks. Cotton is a natural textile micro- and nanofibre. This indicates that the pyrolysis process improves the quality of the carbon materials present, and this is supported by the previous FT-IR analysis.

The TGA measurements are in accordance with the Raman measurements data obtained. Raman spectroscopy provides insights in the nature of the carbon produced by catalytic pyrolysis process (see FIG. 9). For all the spent samples, the first order Raman spectra of cotton and PET is notably different than the fresh sample Raman spectra, and the appearance of two characteristics peaks at around 1350 and 1580 can be seen. These peaks are typical of sp² bonded carbon. The Raman spectra of disordered graphite exhibit two modes, the G peak at 1580-1600 1/cm and the D peak at 1350 1/cm, which are often attributed to phonons with E_{2g} and A_{1g} symmetry, respectively.

The existence of the D peak band indicates the presence of aromatic compounds with a ring size greater than six fused rings. G band is commonly referred to as the “graphite band” because it involves the in-plane bond-stretching motion of pairs of C sp² atoms (E_{2g}), whereas D band is commonly referred to as the “defect band” because it provides information about the morphological disorder and defects that are characteristic of disordered graphite (A_{1g}).

As can be seen in FIG. 9, the shape and position of these bands vary slightly across the different cotton and PET spent samples indicating structural differences between the carbonaceous structures produced by catalytic pyrolysis of the fresh samples. In particular, D band is shifted towards higher Raman shift values in the cotton spent sample, while G band is quite stable in the same value for both spent samples (cotton and PET). This phenomenon indicates the nature of both carbon produced with the different samples. However, the D band, a double-resonant process in Raman, is closely connected to the band structure and its location offers some information on the diameter of carbonaceous species. Due to the low temperatures and brief pyrolysis durations, there is negligible graphitisation in these samples, as seen by the SEM pictures (see FIGS. 10 and 11). When the number of defects rise, the D band usually moves to higher frequencies.

Although Raman spectra give valuable qualitative information, a preliminary quantitative analysis might provide insight on the structural development of carbonaceous materials produced. In this context, the D/G ratio is a semi-quantitative data retrieved from Raman examinations that is of interest. In general, the ratio of the intensities of these bands (D/G) is a crucial parameter for distinguishing the kind of carbon generated during thermal decomposition caused by catalytic pyrolysis process. The conversion of nano-crystalline graphite to amorphous carbon increases the D/G ratio. The D/G ratio value obtained for the cotton and PET spent samples were 0.65 and 0.75, respectively. Therefore, it can be determined that the carbon produced by the utilization of cotton as feedstock is a more crystalline, better-quality type of carbon.

In order to examine the morphological characteristics and structural change of the carbonaceous materials produced, SEM pictures have been produced. FIG. 10A shows the SEM image obtained for a fresh cotton sample, and FIG. 10B shows the SEM image obtained for a spent cotton sample after the catalytic pyrolysis process has occurred. In comparison, a change in the morphology of the sample from fibrous shapes to round carbonaceous substances can be observed. Similarly, FIG. 11A shows the SEM image obtained for a fresh PET sample and FIG. 11B shows the SEM images obtained for a spent PET sample after being subject to the catalytic pyrolysis process. The same structural change from fibrous materials to round carbonaceous particles can be observed.

The distribution of the active metal phase of the heterogeneous catalyst and the possible colocation of carbon grow during the catalytic pyrolysis process was investigated using the energy-dispersive X-ray spectroscopy (EDS) mapping analysis. FIG. 12, in which nickel, iron and carbon were indexed in blue, pink, and red respectively, illustrates a homogeneous distribution of both active phases of the catalyst when cotton is utilised as a feedstock, in addition to a notable distribution of carbon particles collocated in the surface of the catalyst. Similarly, it can be observed in FIG. 13, in which nickel, iron and carbon were indexed in blue, yellow, and red, respectively.

### Conclusions on the Pyrolysis Method

After undergoing a catalytic pyrolysis process, H₂ gas and two distinct kinds of carbonaceous materials were produced using bimetallic Ni—Fe catalysts from textile micro- and nanofibres. For the purpose of comparison, two distinct kinds of textile micro- and nanofibres were examined: cotton, a natural fibre, and PET, a synthetic fibre. At an ideal pyrolysis temperature of 500° C., the greatest H₂ production was attained. TGA, SEM, and Raman analyses have confirmed that both materials used as feedstock (cotton and PET) yielded carbon of high quality. In addition, it has been demonstrated that cotton micro- and nanofibres generated more crystalline carbonaceous material.

### Thermal Conversion Using Hydrothermal Carbonisation (HTC)

FIG. 14 depicts the FT-IR patterns of the samples subjected to hydrothermal carbonisation compared to those taken from a fresh/used sample. The pattern indicates that thermal treatment resulted in distinct changes in the chemical functionalities and, consequently, the chemical composition of both samples, and provides information about the functional groups formed on the surface of the material, which are crucial for determining the degree of carbonisation.

The plots reveal a considerable decrease in C—O—R chemical functionalities. Therefore, FIG. 14 depicts the decline or disappearance of several chemical functionalities. When compared to fresh samples, the presence of broken C—O—R bonds indicates that a carbonisation process is occurring during the hydrothermal carbonisation reaction.

Raman spectroscopy provides insights into the nature of the carbon produced by catalytic HTC process (see FIG. 15). For all of the spent samples, the first order Raman spectra of cotton and PET is notably different than the fresh sample Raman spectra. For cotton, the appearance of two characteristics peaks at around 1350 and 1580 can be observed. These peaks are typical of sp² bonded carbon [102]. The Raman spectra of disordered graphite exhibit two modes, the G peak at 1580-1600 1/cm and the D peak at 1350 1/cm, which are often attributed to phonons with E_{2g} and A_{1g} symmetry, respectively.

As shown in FIG. 15, the shape and position of these bands vary slightly across the different cotton and PET spent samples indicating structural differences between the carbonaceous structures produced by HTC of the fresh samples.

Even though it is clear that the characteristic D,G bands have not appeared for the PET spent sample indicating that the reaction is happening, there is some material that can be combusted, as the TGA data indicated, but this material is not a pure carbonaceous material. The material produced from HTC using PET as feedstock can be hypothesised as being an intermediate between the fresh sample and carbonaceous material. Due to the low temperatures and pressures during the HTC process, there is negligible graphitisation in these samples, as seen by the SEM pictures (see FIGS. 16 and 17).

In addition, the experiments run on real waste samples were analysed. To detect the transformation in the solid material caused by the variations in the temperature/pressure and residence time of the process, the properties of the carbonaceous products formed by HTC of real textile micro/nano fibers were thoroughly examined. The temperatures tested were 200° C., 250° C. and 300° C. As the pressure is autogenerated in the Batch reactor, 50 g of water were always added as a reaction media, so respectively the pressures generated were approximatively 20, 40 and 99 bar. The residence times selected were 1 h, 4 h and 8 h. Therefore for the continuation of this study, the samples were labelled according to the temperature and residence time. For example, the carbonaceous product obtained from the reaction at 200° C. (20 bar) and a residence time of 1 hour were labelled as 200-1.

In this study, the inventors conducted an elemental analysis to investigate the composition and distribution of elements in the samples. The samples were subjected to rigorous preparation techniques, including drying, grinding, and homogenization, to ensure representative analysis. Elemental analysis was performed using X-ray fluorescence spectroscopy (XRF), a non-destructive analytical technique capable of determining the elemental composition of solid, powdered, and liquid samples. The elemental concentrations of key elements, such as carbon, nitrogen, hydrogen, and sulphur, were determined and expressed as weight percentages, and the different values are summarised Table 4. Table 4 presents the weight percentage of carbon (C), hydrogen (H), nitrogen (N), and sulphur (S) in the pre-reaction samples (Fluffy and Hard) and the post-reaction microfibres obtained through the HTC reaction at various temperatures and residence times.

TABLE 4
Elemental analysis results

| | | | | | |
|---|---|---|---|---|---|
| Sample | % C | % H | % N | % S | Total |

Pre-reaction

| | | | | | |
|---|---|---|---|---|---|
| Fluffy | 42.9 ± 0.4 | 6.0 ± 0.1 | 0 | 0 | 48.9 |
| Hard | 43.4 ± 0.5 | 6.1 ± 0.2 | 0 | 0 | 49.5 |

Post-reaction

| | | | | | |
|---|---|---|---|---|---|
| 200-1 | 43.1 ± 0.4 | 6.0 ± 0.3 | 0 | 0 | 49.1 |
| 200-4 | 43.5 ± 0.2 | 6.1 ± 0.1 | 0 | 0 | 49.6 |
| 200-8 | 43.7 ± 0.4 | 6.1 ± 0.1 | 0 | 0 | 49.8 |
| 250-1 | 55.4 ± 0.3 | 5.4 ± 0.2 | 0 | 0 | 60.8 |
| 250-4 | 52.9 ± 2 | 4.8 ± 0.1 | 0 | 0 | 57.7 |
| 300-1 | 70.5 ± 0.3 | 4.7 ± 0.2 | 0 | 0 | 75.2 |
| 300-4 | 70.7 ± 0.4 | 4.7 ± 0.2 | 0 | 0 | 75.4 |

This elemental analysis study provides valuable insights into the elemental composition of the samples. Notably, no traces of sulphur or nitrogen were detected in any of the samples. To account for the high heterogeneity of the pre-reaction samples, the error percentage was calculated based on six measurements. When focusing on the carbon percentage, it can be observed that it ranges from approximately 43% in the pre-reaction microfibers to around 70% in the post-reaction sample obtained at 300° C. with a residence time of 4 hours. Similarly, the hydrogen percentage decreases as the temperature increases. These findings indicate that higher temperatures promote increased carbonisation and dehydrogenation. Additionally, it can be concluded that the residence time has minimal influence on the degree of carbonisation.

SEM images were acquired to examine the surface morphology and microstructure of the microfibres. The SEM images provide high-resolution visualisations, enabling a detailed analysis of the sample's topography, particle size, shape, and surface features. The samples were carefully prepared by mounting them on conductive stubs, followed by sputter coating with a thin layer of a conductive material such as gold. This coating aids in reducing the charging effects and provides enhanced conductivity during imaging. The SEM images were analysed to extract information regarding the surface morphology of the carbonaceous products obtained under varying reaction temperatures and residence times, and are shown in FIG. 19.

It can be observed that at 200° C., there is minimal change in the morphology of the samples, which aligns with the elemental analysis data presented in Table 4. At 250° C., the fibres start to disappear, and amorphous carbonaceous fragments are formed. However, at 300° C., several fibres are observed again, suggesting the production of filamentous carbon at this temperature. Accordingly, it is clear that there is a reaction temperature “sweet spot” of between 200° C. and 300° C.

To complete the characterisation study TEM (Transmission Electron Microscopy) images and EDX (Energy-Dispersive X-ray) scanning were employed to gain insights into the microstructure, and composition of the microfibres. As shown in FIG. 20, the production of valuable carbonaceous product was observed in post-reaction textiles microfibers waste at 300° C. after 4 hours of reaction, i.e., several layers of graphite/graphene were found.

### Conclusions on the Hydrothermal Carbonisation Method

Following the hydrothermal carbonisation procedure, three distinct types of materials were produced using bimetallic Ni—Fe catalysts from textile micro/nanofibres. Two types of textile micro- and nanofibres were studied for comparison: cotton, a natural fibre, and PET, a synthetic fibre. TGA, SEM, and Raman investigations indicated that cotton utilized as a feedstock produced several types of amorphous carbon compounds. When PET is employed as a feedstock, the material generated is believed to be an intermediary between fresh fibres and carbonaceous materials.

Furthermore, in the absence of a catalyst, and when using real textile waste as the feeding stock or starting material, different carbonaceous products can be targeted by adjusting the temperature during the reaction process.

1. A method for converting a textile microfibre and/or textile nanofibre into a carbon nanomaterial, the method comprising thermally cracking a textile microfibre and/or textile nanofibre under conditions that are suitable to convert the textile microfibre and/or textile nanofibre into a carbon nanomaterial.

2. A method of converting a non-biodegradable textile microfibre and/or textile nanofibre into biodegradable and/or biocompatible waste, the method comprising thermally cracking a textile microfibre and/or textile nanofibre under conditions that are suitable to convert the textile microfibre and/or textile nanofibre into biodegradable and/or biocompatible waste.

3. The method according to claim 1 or 2, wherein the method comprises thermally cracking a natural textile micro- and/or nanofibre.

4. The method according to any preceding claim, wherein the method comprises thermally cracking a synthetic or semi-synthetic textile microfibre and/or textile nanofibre.

5. The method according to any preceding claim, wherein the textile microfibre and/or textile nanofibre is obtained from any of the textiles in Table 1, optionally wherein the textile microfibre and/or textile nanofibre is textile waste, optionally collected from washing machines' filters as hard textile waste, and/or from dryers' filters as fluffy textile waste.

6. The method according to any preceding claim, wherein the textile microfibre and/or textile nanofibre is cotton or polyethylene terephthalate (PET).

7. The method according to any preceding claim, wherein the textile microfibre and/or textile nanofibre is naturally formed, knitted, woven, felted, non-woven, or bonded together, optionally through mechanical, thermal or chemical treatment, optionally wherein the textile microfibre and/or textile nanofibre comprises a plastics material.

8. The method according to any preceding claim, wherein the textile microfibre and/or textile nanofibre has an average diameter or length of between 0.1 μm and 5 mm, between 0.1 μm and 4 mm, between 0.1 μm and 3 mm, between 0.1 μm and 2 mm.

9. The method according to any preceding claim, wherein the textile microfibre and/or textile nanofibre has an average diameter or length of:
(i) less than 750 μm, 500 μm, 250 μm, or less than 150 μm; and/or
(ii) less than 100 μm, 75 μm, 50 μm, or less than 35 μm.

10. The method according to any preceding claim, wherein the textile microfibre and/or textile nanofibre has an average length of between 0.01 mm and 0.5 mm, or between 0.02 mm and 0.3 mm, or between 0.05 mm and 0.15 mm.

11. The method according to any preceding claim, wherein the textile microfibre and/or textile nanofibre has an average diameter of between 1 and 100 μm, or between 1 and 75 μm, or between 1 and 50 μm, or between 1 and 40 μm, or between 6 and 36 μm.

12. The method according to any preceding claim, wherein the thermal cracking of the textile microfibre and/or textile nanofibre comprises pyrolysis.

13. The method according to claim 12, wherein the pyrolysis reaction is batch, fed-batch or continuous.

14. The method according to either claim 12 or 13, wherein the pyrolysis reaction is carried out in a one-stage or multi-stage reactor, which is a fixed bed or fluidised reactor.

15. The method according to any one of claims 12-14, wherein the reaction is carried out in a one-stage fixed bed reactor for dry feeds, or in a batch hydrothermal reactor for wet feedstock.

16. The method according to any one of claims 12-15, wherein the pyrolysis reaction is performed at a temperature range of:
(i) between 100° C. and 1000° C., between 20° and 900° C., between 30° and 800° C., between 40° and 700° C., or between 450 and 600° C.;
(ii) between 46° and 550° C., between 47° and 540° C., between 48° and 530° C., or between 49° and 520° C.;
(iii) less than 1000° C., 900° C., 800° C., 700° C., 600° C., or less than 550° C.; and/or
(iv) greater than 100° C., 200° C., 300° C., 400° C., or greater than 450° C.

17. The method according to any one of claims 12-16, wherein the pyrolysis reaction is performed such that it has a residence time of:
(i) between 1 and 200 minutes, between 1 and 175 minutes, 1 and 150 minutes, 1 and 125 minutes, 1 and 100 minutes, 1 and 75 minutes, 1 and 50 minutes, or between 1 and 25 minutes; and/or
(ii) between 25 and 200 minutes, 25 and 175 minutes, 25 and 150 minutes, 25 and 125 minutes, 25 and 100 minutes, 25 and 75 minutes, or 25 and 50 minutes.

18. The method according to any one of claims 12-17, wherein the pyrolysis reaction is performed at atmospheric pressure.

19. The method according to any one of claims 12-18, wherein the pyrolysis reaction is performed with a carrier gas, which maintains an inert or carbonising atmosphere inside the reaction, thus preventing combustion of the feed, preferably wherein the carrier gas is argon or nitrogen.

20. The method according to any one of claims 12-19, wherein the pyrolysis reaction is performed in the absence of a catalyst.

21. The method according to any one of claims 12-20, wherein the pyrolysis reaction is performed in the presence of a catalyst.

22. The method according to claim 21, wherein the catalyst is a single-metallic catalyst or a multi-metallic catalyst.

23. The method according to claim 22, wherein the multi-metallic catalyst is selected from a group consisting of Ni—Mg, Ni—Fe, Ni—Mg—Al, Ni/γ-Al₂O₃, Ni/α-Al₂O₃, Fe/γ-Al₂O₃, Fe/α-Al₂O₃, and Ni—Fe/γ-Al₂O₃.

24. The method according to any one of claims 21-23, wherein the catalyst is the bi-metallic catalyst, Ni—Fe.

25. The method according to any one of claims 21-24, wherein the catalyst is supported by a support composition, optionally wherein the support composition is selected from a group consisting of metal oxides, zeolites, activated carbon, and alumina.

26. The method according to any one of claims 1-11, wherein the thermal cracking of the textile microfibre and/or textile nanofibre comprises hydrothermal carbonisation (HTC).

27. The method according to claim 26, wherein the HTC process uses a solvent in order to regulate the pressure to the desired reaction conditions, preferably wherein the HTC solvent is organic compound or is water.

28. The method according to either claim 26 or 27, wherein the HTC reaction is performed at a temperature range of:
(i) between 50° C. and 650° C., between 100 and 600° C., between 15° and 550° C., between 20° and 500° C., or between 25° and 450° C.;
(ii) between 30° and 440° C., between 32° and 430° C., between 33° and 420° C., or between 34° and 410° C., or between 35° and 400° C.;
(iii) less than 525° C., 500° C., 475° C., 450° C., 425° C., or less than 400° C.;
(iv) greater than 250° C., 275° C., 300° C., 325° C., or greater than 350° C.; and/or
(v) between 15° and 350° C., optionally wherein the HTC reaction is performed at a temperature of about 200° C., 250° C. or 300° C.

29. The method according to any one of claims 26-28, wherein the HTC reaction is be performed such that it has a residence time of:
(i) between 15 minutes and 24 hours; between 30 minutes and 23 hours, 1 and 22 hours, 2 and 21 hours, 3 and 20 hours, 4 and 19 hours, 5 and 18 hours, or 6 and 17 hours;
(ii) between 7 and 16 hours, 8 and 16 hours, 9 and 15 hours, 10 and 14 hours, 11 and 13 hours, or about 12 hours; and/or
(iii) between 1 hour and 8 hours, optionally wherein the HTC reaction is performed such that it has a residence time of 1 hour, 4 hours or 8 hours.

30. The method according to any one of claims 26-29, wherein the HTC reaction is performed at a pressure of between atmospheric pressure and 200 bar, between 5 bar and 200 bar, between 15 and 150 bar, 20 and 150 bar, 30 and 150 bar, 40 and 150 bar, or 20 to 100 bar, optionally wherein the HTC reaction is performed at a pressure of 20, 40 or 99 bar.

31. The method according to any one of claims 26-30, wherein the HTC reaction comprises a non-catalytic HTC reaction, or a catalytic HTC reaction.

32. The method according to claim 31, wherein the catalyst is as defined in any one of claims 22-25.

33. The method according to any preceding claim, wherein the carbon nanomaterial produced by the method is selected from a group consisting of carbon nanofibres (CNFs), carbon nanosheets (CNS), carbon nanotubes (CNT), cup-stacked carbon nanotubes (CS-CNT), hollow carbon spheres (HCS) paracrystalline carbon nanoparticles, graphite, or graphene.

34. The method according to any preceding claim, wherein the method produces hydrogen in addition to the carbon nanomaterial.

35. An apparatus for performing the method according to any one of the preceding claims.

36. The apparatus according to claim 35, wherein the apparatus is configured to thermally crack a textile microfibre and/or textile nanofibre under conditions that are suitable to convert the textile microfibre and/or textile nanofibre into a carbon nanomaterial.
